(19) United States
(12) Patent Application Publication
(10) Pub. No.: US 2011/0308775 A1
(43) Pub. Date: Dec. 22, 2011

(54) ELECTROHYDRODYNAMIC DEVICE WITH FLOW HEATED OZONE REDUCING MATERIAL

(75) Inventor: Kenneth Honer, Santa Clara, CA (US)

(73) Assignee: TESSERA, INC., San Jose, CA (US)

(21) Appl. No.: 12/819,971

(22) Filed: Jun. 21, 2010

(51) Int. Cl. F28D 21/00; H02K 15/00; H02K 44/02

(52) U.S. Cl. 165/120; 417/48; 29/596

(57) ABSTRACT

A thermal management apparatus includes an electrohydrodynamic fluid accelerator energizable to motivate fluid flow. Primary heat transfer surfaces are positioned to transfer heat into the fluid flow and an ozone reducing material is positioned downstream of the primary heat transfer surfaces. Heating of the ozone reducing material by the fluid flow increases the efficacy of the ozone reducing material. A method of making a product includes positioning an emitter electrode and at least one other electrode to motivate fluid flow along a flow path when the electrodes are energized. The method further includes positioning heat transfer surfaces in the flow path to transfer heat to the fluid flow and positioning ozone reducing material downstream of the heat transfer surfaces in the flow path, the ozone reducing material selected such that heating of the ozone reducing material by the fluid flow increases ozone reducing efficacy of the ozone reducing material.

### BACKGROUND

1. Field of the Invention

The present application relates to thermal management, and more particularly, to micro-scale cooling devices that use electrohydrodynamic (EHD, also known as electro-fluid-dynamic, EFD) technology to generate ions and electrical fields to control the movement of fluids, such as air, as part of a thermal management solution to dissipate heat.

2. Description of the Related Art

Devices built using the principle of the ionic movement of a fluid are variously referred to in the literature as ionic wind machines, electric wind machines, corona wind pumps, electro-fluid-dynamics (EFD) devices, electrohydrodynamic (EHD) thrusters and EHD gas pumps. Some aspects of the technology have also been exploited in devices referred to as electrostatic air cleaners or electrostatic precipitators.

In general, EHD technology uses ion flow principles to move fluids (e.g., air molecules). Basic principles of EHD fluid flow are reasonably well understood by persons of skill in the art. Accordingly, a brief illustration of ion flow using corona discharge principles in a simple two electrode system sets the stage for the more detailed description that follows.

With reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11 become ionized and form a stream 14 of ions 16 that accelerate toward second electrode 12, colliding with neutral fluid molecules 22. During these collisions, momentum is imparted from the stream 14 of ions 16 to the neutral fluid molecules 22, inducing a corresponding movement of fluid molecules 22 in a desired fluid flow direction, denoted by arrow 13, toward second electrode 12. Second electrode 12 may be variously referred to as the “accelerating”, “attracting”, “target” or “collector” electrode. While stream 14 of ions 16 is attracted to, and generally neutralized by, second electrode 12, neutral fluid molecules 22 continue past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

Ozone (0₃), while naturally occurring, can also be produced during operation of various electronics devices, including EHD devices, photocopiers, laser printers and electrostatic air cleaners, and by certain kinds of electric motors and generators, etc. Elevated ozone levels have been associated with respiratory irritation and certain health issues. Therefore, ozone emission can be subject to regulatory limits such as those set by the Underwriters Laboratories (UL) or the Environmental Protection Agency (EPA). Accordingly, techniques to reduce ozone concentrations have been developed and deployed to catalytically or reactively break down ozone (O₃) into the more stable diatomic molecular form (O₂) of oxygen.

One such technique has been to provide ozone catalysts on surfaces exposed to fluid flow containing ozone. In such fluid flows, however, a layer of reduced fluid velocity generally forms immediately adjacent to the surface past which the fluid is flowing. This reduced fluid velocity layer is termed a “boundary layer.” The boundary layer can effectively insulate the surface from interaction with the faster moving portion of the fluid flow and therefore limits the degree of ozone reduction.

For example, with reference to FIG. 2, planar surfaces 20 are provided with ozone catalytic coating 22 to catalyze ozone molecules 24 present in air flow 26 flowing in a channel defined by planar surfaces 20. Boundary layers 28 formed adjacent planar surfaces 20 limit the amount of ozone molecules 24 in air flow 26 that may reach catalytic coating 22. The higher velocity portion of air flow 26 outside, or in this case, between boundary layers 28 can carry a significant portion of the ozone molecules 24 past planar surfaces 20 without reacting with catalytic coating 22. Directly heating planar surfaces 20 can provide significant increases in the reactivity of catalytic coating 22 and even in the diffusivity of ozone molecules 24 within air flow 26. However, boundary layer 28 generally remains a significant limiting factor in reaction of ozone molecules 24 with catalytic coating 22.

Improved ozone reduction techniques, and such techniques particularly adapted to EHD devices and deployments are desired.

### SUMMARY

### Electrohydrodynamic (EHD) Fluid Acceleration

Basic principles of electrohydrodynamic (EHD) fluid flow are well understood in the art and, in this regard, an article by Jewell-Larsen, N. et al., entitled “Modeling of corona-induced electrohydrodynamic flow with COMSOL multiphysics” (in the Proceedings of the ESA Annual Meeting on Electrostatics 2008) (hereafter, “the Jewell-Larsen Modeling article”), provides a useful summary. Likewise, U.S. Pat. No. 6,504,308, filed Oct. 14, 1999, naming Krichtafovitch et al. and entitled “Electrostatic Fluid Accelerator” describes certain electrode and high voltage power supply configurations useful in some EHD devices. U.S. Pat. No. 6,504,308, together with sections I (Introduction), II (Background), and III (Numerical Modeling) of the Jewell-Larsen Modeling article are hereby incorporated by reference herein for all that they teach.

It has been discovered that ozone produced by EHD systems may be broken down or otherwise reduced or sequestered by provision of ozone reducing materials downstream from one or more of primary heat transfer surfaces. It particular, it has been discovered that use of a screen, grate, grid network, or other mesh-like material (sometimes referred to herein as simply “mesh”) having a short characteristic length can provide a large amount of surface area with reduced boundary layer conditions and that heating of the ozone reducing material on the mesh by air heated upstream by the primary heat transfer surfaces serves to substantially enhance the efficacy of the ozone reducing material. Accordingly, provision of ozone reducing materials on or in the form of a mesh can provide desirable reductions in ozone levels, particularly when the ozone reducing materials are heated, e.g., by warmer air coming off of primary heat transfer surfaces upstream.

The mesh can be selected to optimize surface area and mesh pore size for ozone interaction. In some implementations, the mesh pore size is selected to minimize likelihood that ozone can pass through unreacted and to not unduly restrict air flow. In some implementations, the mesh is constructed and arranged to present significant surface area within the air flow to accommodate interaction with a substantially portion of the ozone present in the air flow. The combination of surface area, low boundary condition, small mesh pore size and heat can effectively reduce an amount of ozone present in the air flow.

A primary heat transfer surface functions primarily as a radiator or heat sink to efficiently transfer heat to air flowing through or over it. Implementations of radiators or heat sinks often provide a large surface area in contact with the air flow to accomplish this. Primary heat transfer surfaces generally have a large surface area (e.g., an array of thin fins) and sufficiently high thermal conductivity to allow for efficient conduction and convection of heat to and off of the surfaces. While a number of other device surfaces including device housings, air flow outlet grilles, or other air flow boundaries and the like may contribute to radiative or convective device cooling, the terms “primary heat transfer surface” and “radiator” are generally reserved herein for those surfaces that function primarily to transfer heat to an air flow motivated thereover or therebetween.

In some implementations, primary heat transfer surfaces are positioned to transfer heat into an EHD fluid flow; and an ozone reducing material is positioned downstream of one or more of the primary heat transfer surfaces in the fluid flow, the ozone reducing material being heated by the fluid flow, wherein efficacy of the ozone reducing material is thereby thermally enhanced. In some implementations, the ozone reducing material includes at least one of a mesh, grid, lattice or grate through which the motivated fluid flow passes. The mesh, grid, lattice or grate defines a short characteristic length selected to provide a low boundary layer condition. The mesh is further configured to maximize surface area for ozone interaction and to minimize cross-current path lengths, e.g., mesh pore size, to ensure interaction of ozone with ozone reducing material on the mesh surface area. For example, in some cases, a boundary layer thickness adjacent thereto in the fluid flow is limited to less than about 60 microns. In some cases, the ozone reducing material defines an open area of at least about 70 percent.

In some implementations, the heat transfer surfaces are positioned upstream of an EHD emitter electrode in the fluid flow. In some implementations, the heat transfer surfaces are positioned downstream of an EHD emitter electrode in the fluid flow.

In some implementations, a thermal management assembly provides convective cooling of one or more devices within an enclosure. The thermal management assembly defines a flow path for conveyance of air between portions of the enclosure, the thermal management assembly including an EHD fluid accelerator including collector and emitter electrodes energizable to motivate fluid flow along the flow path. Primary heat transfer surfaces are positioned to transfer heat generated by the one or more devices into the fluid flow. An ozone reducing material distinct from the collector electrodes and primary heat transfer surfaces is positioned in the fluid flow at least partially downstream of one or more of the primary heat transfer surfaces.

In some cases, the ozone reducing material includes at least one of a mesh, grid, lattice or grate positioned to cover at least a substantial portion of an outlet portion of a ventilation boundary of the enclosure. In some cases, the ozone reducing material includes at least one of a mesh, grid, lattice or grate positioned to intersect at least a substantial portion of the fluid flow. In some cases, the at least one of a mesh, grid, lattice or grate extends substantially transverse to the flow path across at least a substantial portion of a duct directing the fluid flow.

In some applications, a method of making a product includes positioning an emitter electrode and at least one other electrode to motivate fluid flow along a flow path when the electrodes are energized. The method further includes positioning heat transfer surfaces in the flow path to transfer heat to the fluid flow and positioning ozone reducing material downstream of one or more of the heat transfer surfaces in the flow path, the ozone reducing material selected such that heating of the ozone reducing material by the fluid flow increases ozone reducing efficacy of the ozone reducing material.

In some applications, the product made includes at least one of a computing device, projector, copy machine, fax machine, printer, radio, audio or video recording device, audio or video playback device, communications device, charging device, power inverter, light source, medical device, home appliance, power tool, toy, game console, television, and video display device.

In the present application, some implementations of the devices illustrated and described herein are referred to as electrohydrodynamic fluid accelerator devices, also referred to as “EHD devices,” “EHD fluid accelerators,” and the like. Such devices are suitable for use as a component in a thermal management solution to dissipate heat generated by an electronic circuit amongst other things. For concreteness, some implementations are described relative to particular EHD device configurations in which a corona discharge at or proximate to an emitter electrode operates to generate ions that are accelerated in the presence of electrical fields, thereby motivating fluid flow. While corona discharge-type devices provide a useful descriptive context, it will be understood (based on the present description) that other ion generation techniques may also be employed. For example, in some implementations, techniques such as silent discharge, AC discharge, dielectric barrier discharge (“DBD”) or the like may be used to generate ions that are in turn accelerated in the presence of electrical fields and to motivate fluid flow.

Based on the description herein, persons of ordinary skill in the art will appreciate that provision of ozone reducing materials on particular systems surfaces may likewise benefit systems that employ other ion generation techniques to motivate fluid flow. For example, a DBD system that provides electrical discharge between two electrodes separated by an insulating dielectric barrier may generate ozone, which may be mitigated using techniques described herein. Thus, in the claims that follow, the terms “emitter electrode” and “electrohydrodynamic fluid accelerator” are meant to encompass a broad range of devices without regard to the particular ion generation techniques employed.

In some implementations, an EHD fluid accelerator includes an emitter electrode and a collector electrode(s) energizable to generate ions and to thereby motivate fluid flow along a flow path. Primary heat transfer surfaces (collectively referred to sometimes as a “radiator”) are positioned downstream of the emitter electrode along the flow path. The radiator is coupled into a heat transfer pathway to dissipate heat from a device into the fluid flow.

In some implementations, the radiator is distinct from the collector electrode, but proximate thereto in the flow path. In some cases, the radiator is positioned immediately downstream of the collector electrode. In some cases, the radiator abuts the collector electrode. In some cases the radiator is spaced a distance apart from the collector electrode. Still, in some implementations, the downstream radiator and the collector electrode are constituent surfaces of a unitary structure that functions both as the collector electrode and as a radiator. In some cases, the downstream radiator and the collector are separately formed, but joined to form the unitary structure. In some cases, the radiator and collector are integrally formed.

In some implementations, the ozone reducing material is provided on or formed as a mesh. In some cases, the ozone reducing material is selected from a group that includes: silver (Ag); silver oxide (Ag₂O); and an oxide of manganese, manganese dioxide (MnO₂); and an oxide of nickel (Ni), palladium, cobalt, iron and carbon. In some implementations, the mesh is a wire mesh or a polymeric mesh, formed, e.g., via molding, stamping, electroforming, sintering or other suitable process. In some cases, ozone reducing material may also be present on the radiator or other upstream or downstream surfaces.

It is desirable in various implementations for a mesh to be selected to provide effective ozone reduction without undue restriction of air velocity along the fluid path. Thus, the open area or pore size of the mesh may be selected to achieve a desired ozone reduction and target flow rate impact. In some cases, the mesh defines an open area of at least about 70 percent. The open area can be sized to produce minimal resistance to air flow, e.g., less than about 5 percent reduction of flow.

Similarly, the spacing between elements of the mesh affects the degree of mass transfer of ozone to ozone reducing material of the mesh. In a particular implementation, the mesh comprises a 25 micron wire having an open area of about 80 percent and 200 micron square apertures.

The mesh can also be sized to avoid clogging by particulate, which may also be addressed by precipitation of particulate upstream, e.g., via a collection electrode or via an electrostatic precipitator. Accordingly, improved upstream precipitation of particulate may allow for use of finer mesh materials in some cases.

In some applications, the primary heat transfer surfaces operate at about 70 degrees C. The air flow passing over the primary heat transfer surface is thereby heated and advantageously accelerates ozone diffusion transport and enhances reactivity of the ozone reducing material on the mesh. In some cases, the reactivity of the ozone reducing material is enhanced by several orders of magnitude relative to efficacy at room temperature. Similarly, as temperature increases, diffusion of the ozone increases within the air flow. Increased air flow temperature can also reduce adsorption of moisture to downstream surfaces that could otherwise prevent ozone reaction.

Employing closely spaced mesh elements having a small characteristic length provides both a thin boundary layer and increased mass transfer of ozone to ozone reducing material of the mesh. Due to the short characteristic length, the mesh structure produces a low boundary layer condition and allows the ozone to more easily reach the mesh surface.

In some applications, a method of making a product includes providing a mesh with ozone reducing material and positioning the mesh downstream of primary heat transfer surfaces and an emitter electrode in an EHD device. In some applications, the method further includes fixing the emitter electrode proximate to leading surfaces of a collector electrode(s) such that, when energized, the electrodes motivate fluid flow over the primary heat transfer surface and through the mesh. The emitter electrode, collector electrode and primary heat transfer surfaces are so positioned and fixed to constitute a thermal management assembly.

In some applications, the method includes introducing the thermal management assembly into an electronic device and thermally coupling a heat generating or dissipating device thereof to the primary heat transfer surfaces. In some cases, the electronic device includes at least one a computing device, projector, copy machine, fax machine, printer, radio, audio or video recording device, audio or video playback device, communications device, charging device, power inverter, light source, medical device, home appliance, power tool, toy, game console, television, and video display device.

In some implementations, the emitter electrode is an elongated wire and the collector electrode includes two elongated plates substantially parallel to the emitter electrode. Of course, the emitter and collector electrodes may be selected and arranged in any manner suitable to generate ions and thereby motivate fluid flow.

In some cases, additional electrodes, e.g., accelerator electrodes, may be used adjacent the mesh to help maintain fluid flow velocity through the mesh. Suitable additional electrode(s) may include an attracting electrode, a repelling electrode, or a combination thereof.

Advantages of use of an EHD device for thermal management in such devices includes substantially silent operation, reduced power consumption, reduced vibration, reduced thermal solution footprint and volume, and form factor flexibility, e.g., capability to utilize space around other electronics.

The detailed description refers to the accompanying drawings that show, by way of illustration, specific aspects and implementations in which the present disclosed teaching may be practiced. Other arrangements and implementations may also be utilized, and structural, logical, and electrical changes may be made without departing from the scope of the disclosed implementations. The various implementations are not necessarily mutually exclusive, as some implementations can be combined with one or more other implementations to form new implementations.

### BRIEF DESCRIPTION OF THE DRAWINGS

The present invention may be better understood, and its numerous objects, features, and advantages made apparent to those skilled in the art by referencing the accompanying drawings.

FIG. 1 is a depiction of certain basic principles of electrohydrodynamic (EHD) fluid flow.

FIG. 2 is a depiction of certain basic principles of convective cooling including diffusion and boundary layers.

FIG. 3 depicts an ozone reducing mesh material having a small characteristic length to minimize boundary layer thickness and optimize ozone reduction.

FIG. 4 is a top view of an EHD fluid accelerator motivating air along a bounded fluid path past heat transfer surfaces and through an ozone reducing mesh.

FIG. 5 is a front view of the EHD fluid accelerator and ozone reducing mesh of FIG. 4.

FIG. 6A-6C depict perspective views of ozone reducing mesh positioned downstream of various illustrative integrated collector and radiator structures for use in EHD fluid accelerators.

FIG. 7 depicts an end-on view of ozone reducing mesh material positioned a distance downstream of separate collector and radiator structures.

FIG. 8 depicts an end-on view of ozone reducing mesh material abutting a radiator structure.

FIG. 9 depicts an electronic system using various implementations as described herein.

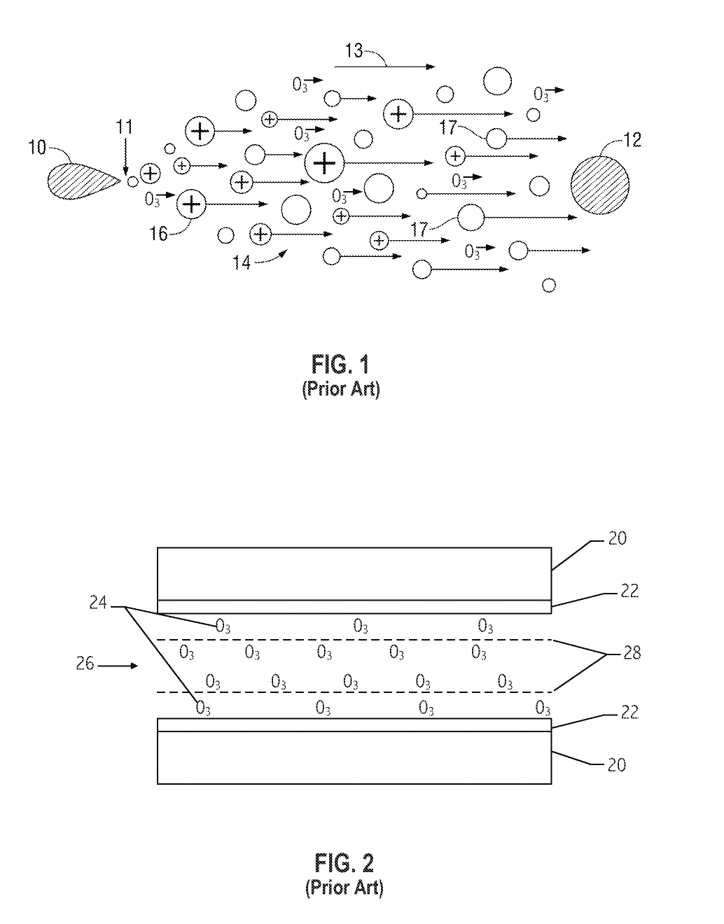

The use of the same reference symbols in different drawings indicates similar or identical items.

### DETAILED DESCRIPTION

Some implementations of thermal management systems described herein employ EHD devices to motivate flow of a fluid, typically air, based on acceleration of ions generated as a result of corona discharge. Other implementations may employ other ion generation and motivation techniques and will nonetheless be understood in the descriptive context provided herein. For example, in some implementations, techniques such as silent discharge, AC discharge, dielectric barrier discharge (DBD) or the like may be to generate ions that are in turn accelerated in the presence of electrical fields to motivate fluid flow.

Typically, when a thermal management system is integrated into an operational environment, heat transfer paths (often implemented as heat pipes or using other technologies) are provided to transfer heat from where it is generated or dissipated to a location(s) within an enclosure where air flow motivated by an EHD device(s) flows over primary heat transfer surfaces. For example, heat generated by various system electronics (e.g., microprocessors, graphics units, etc.) and/or other system components (e.g., light sources, power units, etc.) can be transferred via a heat pipe to radiator fins and then to a cooling fluid and exhausted from the enclosure. Of course, while some implementations may be fully integrated in an operational system such as a laptop or desktop computer, a projector or video display device, printer, photocopier, etc., other implementations may take the form of subassemblies.

In some implementations, a screen, grate, grid network or other mesh-like material (“mesh”) including ozone reducing material is positioned downstream of the radiator such that heat transferred from the radiator to the air flow enhances the reactivity or efficacy of the ozone reducing material.

In some implementations, the mesh is positioned a distance downstream from the radiator. In some implementations, the mesh abuts the radiator. In some implementations, the mesh is integrated with the radiator. In some implementations, the mesh is positioned substantially downstream of the radiator. In some cases, the mesh is abutting or positioned between trailing portions of elements, e.g., fins, of the radiator.

In some implementations, a monolithic structure may act as a collector electrode and radiator. In some implementations, the collector electrodes and radiator are provided (or at least fabricated) as separate structures that may be mated, integrated or more generally positioned proximate each other in operational configurations. These and other variations will be understood with reference to the described implementations.

In general, a variety of scales, geometries, positional interrelationships and other design variations are envisioned for emitter and collector electrodes of a given device. An ozone reducing mesh may be used with any number of radiator and electrode configurations. For concreteness of description, certain illustrative implementations, surface profiles and positional interrelationships with other components are described herein. For example, plural planar collector electrodes may be arranged in a parallel, spaced-apart array proximate to an emitter wire; or planar portions of the collector electrodes may be oriented generally orthogonally to the longitudinal extent of an emitter wire.

In some thermal management system implementations, collector electrodes can provide significant heat transfer to fluid flows motivated therethrough or thereover. In some cases, the collector electrodes can also serve as a primary heat transfer surface. In some thermal management implementations, the primary heat transfer surfaces do not participate substantially in EHD fluid acceleration, i.e., they do not serve as electrodes.

It will be understood that particular EHD design variations are included for purposes of illustration and, persons of ordinary skill in the art will appreciate a broad range of design variations consistent with the description herein. In some cases, and particularly in the illustration of flow paths, EHD designs are illustrated simply as a corona discharge electrode assembly and a collector electrode assembly proximate each other; nonetheless, such illustrations within the broad context of a full range of EHD design variations are described herein.

Although implementations of the present invention are not limited thereto, much of the description herein is consistent with geometries, air flows, and heat transfer paths typical of laptop-type computer electronics and will be understood in view of that descriptive context. Of course, the described implementations are merely illustrative and, notwithstanding the particular context in which any particular implementation is introduced, persons of ordinary skill in the art having benefit of the present description will appreciate a wide range of design variations and exploitations for the developed techniques and configurations. Indeed, EHD device technologies present significant opportunities for adapting structures, geometries, scale, flow paths, controls and placement to meet thermal management challenges in a wide range of applications, systems and devices of various form factors. Moreover, reference to particular materials, dimensions, packaging or form factors, thermal conditions, loads or heat transfer conditions and/or system designs or applications is merely illustrative. In view of the foregoing and without limitation on the range of designs encompassed within the scope of the appended claims, we now describe certain illustrative implementations.

### Ozone Reducing Mesh Materials

As used herein, the term “mesh” refers to any material having a plurality of closely spaced apertures or interstices to provide a certain amount of open area through which a fluid may flow. The apertures or interstices may be defined in a monolithic membrane, foil or film or may be defined by a multiplicity of discreet closely spaced elements.

As used herein, the terms “ozone reducing material” refers to any material useful to catalyze, bind, sequester or otherwise reduce ozone. Ozone reducing materials may be provided in the form of a coating on a substrate, e.g., as a catalyst on a polymeric mesh. Alternatively, the mesh or other surface or component may, itself, be made from an ozone reducing material. For example, a number of catalytic metals may be used to form a suitable wire mesh.

The terms “surface conditioning” and “conditioning materials” refer to any surface coating, surface deposit, surface alteration or other surface treatment suitable to provide ozone reduction, low surface adhesion, or other surface-specific performance or benefits described herein. In some implementations, ozone reducing materials are provided in the form of “surface conditioning” on certain surfaces, e.g., on radiator surfaces, collector electrode surfaces, or other surfaces. References to leading, trailing, upstream, or downstream are to be understood with directional reference to EHD fluid flow.

Primary heat transfer surfaces in some implementations include radiator surfaces. Secondary heat transfer surfaces may include device enclosures or casings, duct sidewalls, outlet grills, heat spreaders and the like, which may serve to dissipate some heat from a device, even if not directly thermally coupled to a heat source per se. In some implementations, the primary heat transfer surfaces are non-ion collection surfaces.

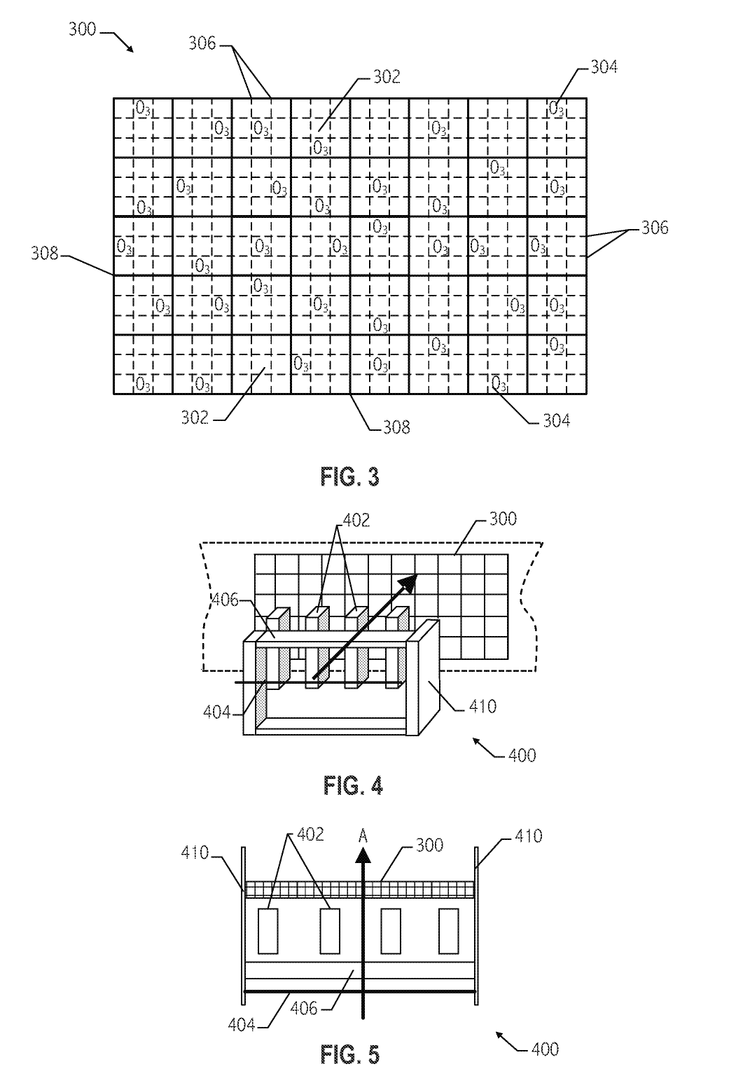

Referring to FIG. 3, an illustrative ozone reducing mesh 300 defines a network of apertures 302 therethrough to accommodate air flow bearing ozone molecules 304. During operation, fluid flow causes boundary layers 306 to form adjacent the mesh surfaces or mesh elements 308 defining apertures 302. Mesh elements 308 comprise ozone reducing material (not separately illustrated), e.g., ozone catalyst or catalyst binder, selected to catalyze, bind, sequester or otherwise reduce ozone molecules 306 present in an air flow.

Mesh elements 308 are positioned and/or apertures 302 sized to provide effective ozone reduction without undue restriction of the air flow. As illustrated, apertures 302 may be sized and arranged such that diffusivity of ozone molecules 306 in the air flow brings a significant portion of the total ozone content of the air flow in contact with mesh elements 308, and thereby in contact with ozone reducing material.

Mesh elements 308 are sized to provide a relatively short characteristic length to ensure a sufficiently thin boundary layer for penetration of an appreciable amount of ozone through the boundary layer to elements 308. For example, mesh 300 may be made of a monolithic or from discreet filaments, wires, threads, or liked elements of suitable thickness to present ozone reducing material to the air flow without producing a substantial boundary layer.

Any type of perforated film, porous fabric woven fabric, non-wove material or other material suitable to present ozone reducing material within an air flow may be used in accord with various implementations.

While mesh 300 is depicted as being of a substantially uniform and symmetrical construction, apertures 308 may be of varying sizes and shapes. Similarly, mesh 300 need not present a uniform concentration or composition of ozone reducing material. For example, a first ozone reducing material may be provided at a first portion of mesh 300 while a second ozone reducing material is provided at a second portion of mesh 300. In some cases, ozone reducing material may be omitted from selected portions of mesh 300. Any number, type or combination of ozone reducing materials may be used to provide a coating on or otherwise form part of mesh 300.

Suitable mesh materials may include metallic wire, wire cloth, carbon filaments, fiberglass, polymeric, woven and non-woven fabrics, perforated films or foils; point bonded polymeric weaves, batting, and other materials suitable for presenting an ozone reducing material and accommodating heated air flow therethrough.

Ozone reducing materials can include ozone catalysts, ozone catalyst binders, ozone reactants or other materials suitable to react with, bind to, or otherwise reduce or sequester ozone. Suitable ozone reducing materials include silver (Ag), silver oxide (Ag2O), manganese dioxide (MnO2), oxides of nickel (Ni), palladium, cobalt, iron and carbon. Ozone reducing materials can be selected to also target other undesirable airborne materials and pollutants.

Referring to FIGS. 4-5, mesh 300 is positioned downstream of an EHD device 400 and heat transfer surfaces 402. EHD device 400 includes one or more collector electrodes 406 in spaced relation to an emitter electrode 404 energizable to generate ions to motivate fluid flow, which is illustrated by directional arrow “A.”

Heat transfer surfaces 402 are thermally coupled to a heat generating device, e.g., an electronic device such as a microprocessor. During operation of EHD device 400, air flow “A” passes over heat transfer surfaces 402 transferring heat from surfaces 402 to air flow “A” to provide convective cooling. As the heated air flow “A” travels downstream through mesh 300, ozone generated by EHD device 400 reacts with ozone reducing material on mesh 300.

Heating of mesh 300 by heated air flow “A” enhances the efficacy of the ozone reducing material of mesh 300. For example, in some cases, catalytic ozone reducing materials are more than 50 times more reactive at 80 degrees Celsius than at room temperature. Accordingly, positioning of mesh 300 to be heated by air flow “A” downstream of heat transfer surfaces 402 provides increased effectiveness of ozone reduction in air flow “A”.

In some implementations, ozone reducing materials can also be provided on heat transfer surfaces 402, channel walls 410, collector electrodes 406 or other system surfaces. In some implementations, secondary, potentially less reactive or catalytic, ozone destructive materials can be used on ion collection surfaces to enhance or maximize the total ozone destruction in the system.

In some implementations, ozone reducing materials may also be provided upstream of the emitter electrode to compensate for any diffusion upstream of ozone. For example, the diffusivity of ozone in a relatively slow fluid flow, e.g., less than 1 m/s, may result in ozone migrating upstream of the emitter electrode. Accordingly, it may be desirable to provide ozone reducing material upstream.

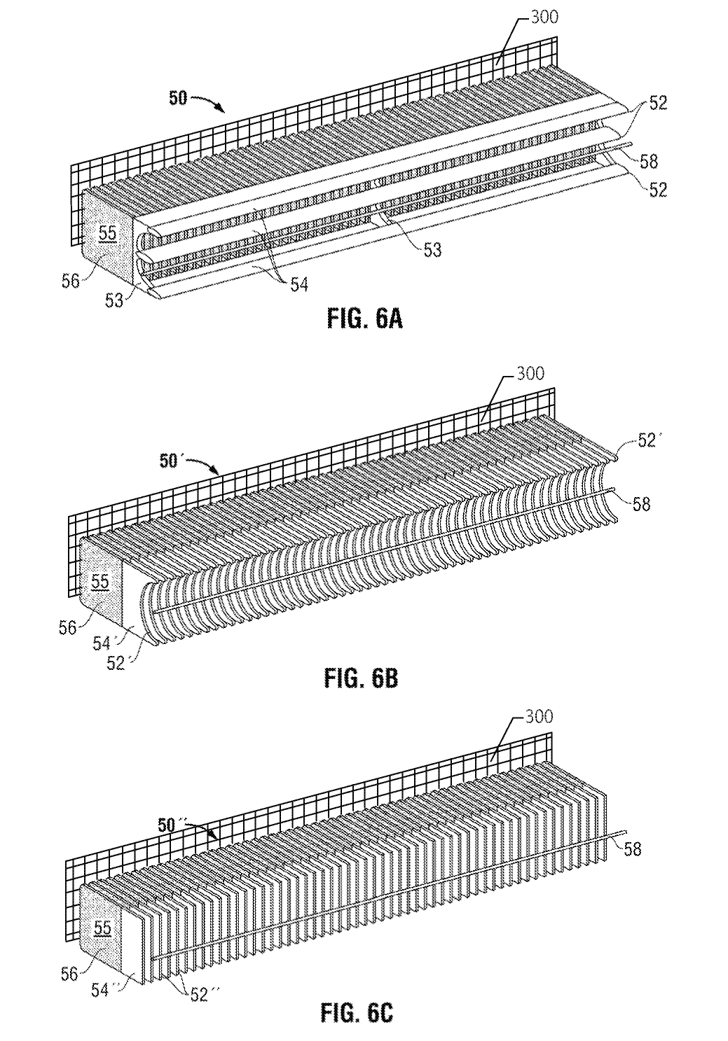

Referring to FIGS. 6A-6C, mesh 300 may be used to reduce ozone in an air flow motivated by various configurations of EHD devices 50, 50′, 50″. With reference to FIG. 6A, EHD device 50 includes multiple collector-electrodes 54, e.g., planar fins, arranged substantially parallel to electrode 58. Collector electrodes 54 are positioned by supports 53 with front edges 52 arranged substantially equidistant from electrode 58. Separate primary heat transfer surfaces 56 are positioned downstream of collector electrodes 54. Air passing over primary heat transfer surfaces 56 is heated and continues downstream through mesh 300.

Mesh 300 is provided with an ozone reducing material characterized by ozone reactivity or other ozone reducing efficacy that is thermally enhanced by passage of heated air flow therethrough. In some implementations, mesh 300 is sized to provide a short characteristic length and resulting thin boundary layer for effective ozone transfer to ozone reducing material of mesh 300.

In some cases, the ozone reducing material of mesh 300 includes at least one of silver (Ag), silver oxide (Ag2O), manganese dioxide (MnO2), oxides of nickel (Ni), palladium, cobalt, iron and carbon.

In some implementations, primary heat transfer surfaces 56 are also provided with ozone reducing material 55 or other surface conditioning, e.g., to provide dendrite inhibiting properties or other surface properties described herein. Ozone reducing material 55 on heat transfer surfaces 56 may differ from the ozone reducing material of mesh 300.

Leading edge collector surfaces 52 may comprise the bulk of collector surfaces 54 in cases where collector surfaces 54 are oriented substantially orthogonal to surfaces 56 along an array of surfaces 56. Collector surface supports 53 may be provided at intervals along collector surface 54. In some implementations, collector surfaces 54 are substantially parallel to electrode 58 while surfaces 56 are substantially perpendicular to electrode 58.

In addition to ozone, electrode 58 may produce silica particulate that may accumulate in the form of dendrites on downstream surfaces. Accordingly, collector surfaces 54 may be provided with surface conditioning materials selected to reduce adhesion of dendrites or other deleterious materials while heat transfer surfaces 56 are provided with ozone reducing material 55.

With reference to FIGS. 6B-6C, collector electrode surfaces 54′, 54″ and radiator surfaces 56 of EHD devices 50′, 50″ may be combined to form an integrated collector-radiator structure. In some cases, surfaces 54′, 54″ and 56′ may be integrally formed or may be separately formed and thereafter integrated. In various implementations, collector structures and radiator structures may be spaced apart, closely spaced, or even abutting depending on the application. Similarly, surfaces 54′, 54″ and 56′ may be of any size and geometry suitable to a given application to provide a desired degree of heat transfer, ion collection, and surface specific performance, e.g., ozone reduction.

With reference to FIG. 6B, collector surfaces 54′ define a curved front edge 52 in spaced relation to electrode 58. With reference to FIG. 6C, collector surfaces 54″ presents a substantially linear front edge 52″ in spaced relation to electrode 58. In some cases, surfaces 54′, 54″ may be connected along a top and/or bottom edge by a support structure. Collector surfaces 54′, 54″, and similarly heat transfer surfaces 56 may be arranged and spaced to provide desired fluid flow dynamics therebetween. In generally, a boundary layer forms along heat transfer surfaces 56′. This boundary layer can reduce interaction of ozone in the air flow with any ozone reducing material provided on heat transfer surfaces 56′. Accordingly, mesh 300 having a reduced boundary layer condition is provided downstream of heat transfer surfaces 56′ to further reduce ozone levels in the air flow.

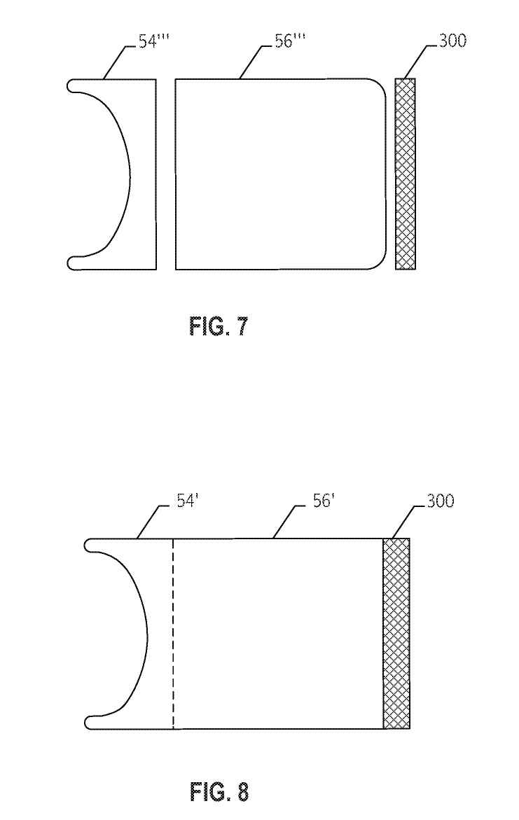

With reference to FIG. 7, in some implementations, mesh 300, collector electrode 54″′ and heat transfer surface 56″′ may be spaced apart along the air flow path.

With reference to FIG. 8, in some implementations, mesh 300, collector electrode 54′ and heat transfer surface 56′ may be abutting or closely spaced. Proximity of mesh 300 to heat transfer surface 56′ may increase thermal transfer to mesh 300, increasing the efficacy of ozone reducing material of mesh 300.

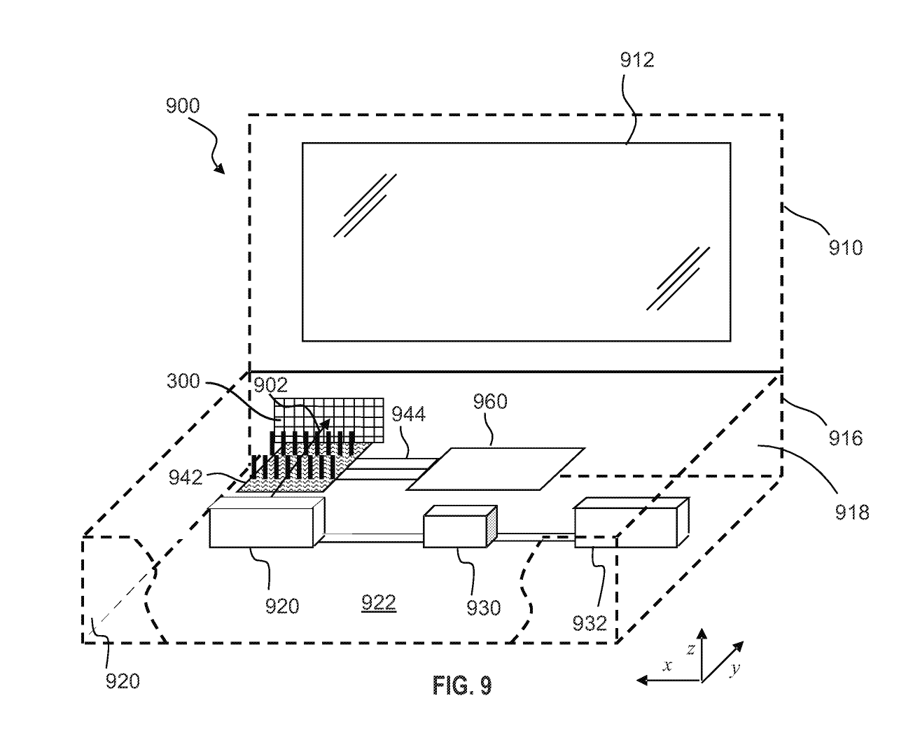

FIG. 9 is a schematic block diagram illustrating one implementation of an electronic device 900 in which an EHD or EFA air cooling system 920 may operate. An electronic device 900 such as a computer comprises a housing 916, or case, having a cover 910 that includes a display device 912. A portion of the front surface 921 of housing 916 has been cut away to reveal interior 922. Housing 916 of electronic device 900 may also comprise a top surface (not shown) that supports one or more input devices that may include, for example, a keyboard, touchpad and tracking device. Electronic device 900 further comprises electronic circuit 960 which generates heat in operation. A thermal management solution comprises a heat pipe 944 that draws heat from electronic circuit 960 to heat sink device 942.

In some implementations, mesh 300 is thermally insulated from housing 916, to mitigate heating of housing 916. It may be advantageous to provide thermal resistance between mesh 300 and housing 916 to mitigate heating of housing 916 by mesh 300.

Alternatively, mesh 300 may be thermally coupled to housing 926, e.g., thermal resistance may be minimized, such that the electronic device housing 926 serves as a heat sink to mesh 300 to reduce outgoing air temperature. In some cases, control of air temperature may be more critical than control of housing temperature, e.g., in the case of a projector.

Device 920 is powered by high voltage power supply 930 and is positioned proximate to heat sink 942. Electronic device 900 may also comprise many other circuits, depending on its intended use; to simplify illustration of this second implementation, other components that may occupy interior area 922 of housing 920 have been omitted from FIG. 9.

With continued reference to FIG. 9, in operation, high voltage power supply 930 is operated to create a voltage difference between emitter electrodes and collector electrodes disposed in EHD device 920, generating an ion flow or stream that moves ambient air toward the collector electrodes. The moving air leaves device 920 in the direction of arrow 902, traveling through the fins or protrusions of heat sink 942 and through a mesh 300 at the rear surface 918 of housing 916, and thereby dissipating heat accumulating in the air above and around heat sink 942. Mesh 300 presents an ozone reducing material to catalyze, react with or otherwise reduce ozone present in the air flow, e.g., ozone generated by EHD device 920. Mesh 300 may be grounded when metallic mesh materials are used.

Note that electronic device 900 has been greatly simplified for purposes of illustration and the position of illustrated components, e.g., of power supply 930 relative to device 920 and electronic circuit 960, may vary from that shown in FIG. 9. While device 900 is depicted as a laptop computing device, tablet devices, and handheld devices may likewise benefit from EHD cooling and ozone reduction as described.

A controller 932 is connected to device 920 and may use sensor inputs to determine the state of the air cooling system, e.g., to determine a need for cleaning electrodes. Alternatively, cleaning may be initiated by controller 932 on a timed or scheduled basis, on a system efficiency measurement basis or by other suitable methods of determining when to clean electrodes. For example, detection of electrode arcing or other electrode performance characteristics may be used to initiate movement of the cleaning mechanism to condition the electrode.

In some implementations, cleaning or other electrode conditioning is performed when the electrode is not in use, e.g., during a power on or power off cycle of electronic device 900, or subcomponents thereof. In some cases, conditioning or cleaning may be initiated by controller 932 based upon one or more of an imposed voltage level, a measured electrical potential, determination of the presence of a level of contamination by optical means, by detection of an event or performance parameter, or other methods indicating a need for mechanically cleaning the electrode.

Some implementations of thermal management systems described herein employ EHD or EFA devices to motivate flow of a fluid, typically air, based on acceleration of ions generated as a result of corona discharge. Other implementations may employ other ion generation techniques and will nonetheless be understood in the descriptive context provided herein. Using heat transfer surfaces that may or may not be monolithic or integrated with collector electrodes, heat dissipated by electronics (e.g., microprocessors, graphics units, etc.) and/or other components can be transferred to the fluid flow and exhausted. Typically, when a thermal management system is integrated into an operational environment heat transfer paths (often implemented as heat pipes or using other technologies) are provided to transfer heat from where it is dissipated (or generated) to a location (or locations) within the enclosure where air flow motivated by an EHD or EFA device (or devices) flows over heat transfer surfaces. The heated air flow serves to increase the efficacy of an ozone reducing material provided on a mesh characterized by a low boundary layer condition.

In some implementations, an EHD or EFA air cooling system or other similar ion action device may be integrated in an operational system or a subassembly of a computing device, projector, copy machine, fax machine, printer, radio, audio or video recording device, audio or video playback device, communications device, charging device, power inverter, light source, medical device, home appliance, power tool, toy, game console, television, and video display device, etc. Various features may be used with different devices including air movers, film separators, film treatment devices, and air particulate cleaners.

While the forgoing represents a description of various implementations of the invention, it is to be understood that the claims below recite the features of the present invention, and that other implementations, not specifically described hereinabove, fall within the scope of the present invention. These and other implementations will be understood with reference to the claims that follow.

What is claimed is:

1. An apparatus comprising:
an electrohydrodynamic (“EHD”) fluid accelerator energizable to motivate fluid flow;
primary heat transfer surfaces positioned to transfer heat into the fluid flow; and
an ozone reducing material positioned downstream of one or more of the primary heat transfer surfaces in the fluid flow, the ozone reducing material heated by the fluid flow, wherein efficacy of the ozone reducing material is thereby thermally enhanced.

2. The apparatus of claim 1, wherein the ozone reducing material includes at least one of a mesh, grid, lattice or grate through which the motivated fluid flow passes; and wherein the at least one of a mesh, grid, lattice or grate defines a short characteristic length selected to provide a low boundary layer condition.

3. The apparatus of claim 2, wherein the at least one of a mesh, grid, lattice or grate is constructed and arranged to limit a fluid flow boundary layer thickness adjacent thereto to less than about 70 microns.

4. The apparatus of claim 1, wherein the ozone reducing material includes multiple closely spaced elements, each defining a short characteristic length to minimize of a boundary layer thickness adjacent the elements in the fluid flow.

5. The apparatus of claim 1, wherein the ozone reducing material includes at least one of an ozone catalyst, an ozone catalyst binder and an ozone reactive material.

6. The apparatus of claim 5, wherein ozone reducing material includes at least one of:
silver (Ag);
silver oxide (Ag2O);
manganese dioxide (MnO2);
an oxide of nickel (Ni);
palladium;
cobalt;
iron; and
carbon.

7. The apparatus of claim 1, wherein the ozone reducing material comprises a mesh defining an open area of at least about 70 percent.

8. The apparatus of claim 1, wherein one or more of the heat transfer surfaces are positioned upstream of an emitter electrode of the EHD fluid accelerator in the fluid flow.

9. The apparatus of claim 1, wherein the heat transfer surfaces are positioned downstream of an emitter electrode of the electrohydrodynamic fluid accelerator in the fluid flow.

10. The apparatus of claim 1, wherein the heat transfer surfaces include leading portions that act as collector electrodes of the electrohydrodynamic fluid accelerator.

11. The apparatus of claim 10, wherein the leading portions of the heat transfer surfaces are substantially exposed to ion bombardment and are not provided with an ozone reducing material.

12. An apparatus comprising:
an enclosure;
a thermal management assembly for use in convective cooling of one or more devices within the enclosure, the thermal management assembly defining a flow path for conveyance of air between portions of the enclosure, the thermal management assembly including an electrohydrodynamic (EHD) fluid accelerator including collector and emitter electrodes energizable to motivate fluid flow along the flow path;
primary heat transfer surfaces positioned to transfer heat generated by the one or more devices into the fluid flow; and
an ozone reducing material positioned in the fluid flow downstream of one or more of the primary heat transfer surfaces, wherein the ozone reducing material is distinct from the collector electrodes and primary heat transfer surfaces.

13. The apparatus of claim 12, wherein the ozone reducing material includes at least one of a mesh, grid, lattice or grate positioned to cover at least a substantial portion of an outlet portion of a ventilation boundary of the enclosure.

14. The apparatus of claim 12, wherein the ozone reducing material includes at least one of a mesh, grid, lattice or grate positioned to intersect at least a substantial portion of the fluid flow.

15. The apparatus of claim 14, wherein the at least one of a mesh, grid, lattice or grate extends substantially transverse to the flow path across at least a substantial portion of a duct directing the fluid flow.

16. The apparatus of claim 14, wherein the at least one of a mesh, grid, lattice or grate is substantially thermally insulated from the enclosure to mitigate conduction of heat to the enclosure.

17. The apparatus of claim 14, wherein the at least one of a mesh, grid, lattice or grate is thermally coupled to the enclosure to conduct heat to the enclosure.

18. A method of making a product, the method comprising:
positioning an emitter electrode and at least one other electrode to motivate fluid flow along a flow path when the electrodes are energized;
positioning heat transfer surfaces in the flow path to transfer heat to the fluid flow; and
positioning ozone reducing material downstream of one or more of the heat transfer surfaces in the flow path, the ozone reducing material selected such that heating of the ozone reducing material by the fluid flow increases ozone reducing efficacy of the ozone reducing material.

19. The method of claim 18, wherein the ozone reducing material comprises at least one of a mesh, grid, lattice or grate material defining a short characteristic length to provide a low boundary layer condition.

20. The method of claim 19, wherein the at least one of a mesh, grid, lattice or grate material defines apertures therethrough sized to minimize passage of unreacted ozone without overly restricting the fluid flow.

21. The method of claim 18, further comprising providing the ozone reducing material on a respective mesh substrate via one of dip coating, spray coating, plating, electroplating, anodizing or alodizing.

22. The method of claim 18, further comprising introducing the electrodes, heat transfer surfaces and ozone reducing material into an electronic device and thermally coupling a heat dissipating device to the heat transfer surfaces.

23. The method of claim 18, wherein the product made constitutes a portion of one of a computing device, projector, copy machine, fax machine, printer, radio, audio or video recording device, audio or video playback device, communications device, charging device, power inverter, light source, medical device, home appliance, power tool, toy, game console, television, and video display device.
